(19) United States
(12) Patent Application Publication
(10) Pub. No.: US 2010/0283431 A1
(43) Pub. Date: Nov. 11, 2010

(54) INFORMATION PROCESSING APPARATUS AND METHOD FOR CONTROLLING BATTERY CHARGE

(75) Inventor: Akio KANO, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/728,049

(22) Filed: Mar. 19, 2010

(30) Foreign Application Priority Data
May 11, 2009 (JP) 2009-114264

(51) Int. Cl. H02J 7/04; G06F 1/20

(52) U.S. Cl. 320/150; 361/679.48

(57) ABSTRACT

An information processing apparatus according to an embodiment includes: a heat generating body; a temperature sensor configured to detect a temperature of the heat generating body; a battery in the information processing apparatus; an adaptor configured to supply power from an external power source to the battery to charge the battery; and a controller configured to control a charging operation for charging the battery to be performed in one of a rapid charging or a normal charging based on the temperature detected by the temperature sensor and a threshold temperature lower than a rated temperature of the heat generating body while a power of the information processing apparatus is turned off.

### CROSS REFERENCE TO RELATED APPLICATION(S)

The present disclosure relates to the subject matters contained in Japanese Patent Application No. 2009-114264 filed on May 11, 2009, which are incorporated herein by reference in its entirety.

### FIELD

The present invention generally relates to an information processing apparatus and a method for controlling battery charge capable of performing rapid charging of a battery by using a large current.

### BACKGROUND

There have been conventionally developed products, which are capable of shortening charging times by charging batteries using a large current, for information processing apparatuses such as personal computers (PCs).

A publication JP-A-2009-011068 discloses an information processing apparatus including a cooling determining unit that determines whether or not to drive a battery cooling fan and a main cooling fan in order to cool a battery recharger.

However, although suppressing the maximum electric power required to rapidly charge the battery when the information processing apparatus is turned on, the above technique cannot perform heat generation control during battery charging when the information processing apparatus is turned off.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing an information processing apparatus according to an embodiment of the present invention.

FIG. 2 is a block diagram showing a system configuration of the information processing apparatus shown in FIG. 1.

FIG. 3 is a block diagram showing apart of the system configuration of the information processing apparatus shown in FIG. 1 in more detail.

FIG. 4 is a schematic view showing arrangement of a charging circuit, a cooling fan, a battery and a temperature sensor in the information processing apparatus shown in FIG. 1.

FIG. 5 is a view showing a table of a correspondence between the temperature indicated by the temperature sensor and the rotational speed of the cooling fan, which is stored in a nonvolatile memory (NVRAM) of EC/KBC.

FIG. 6 is a view showing an example battery charging control method used in the information processing apparatus shown in FIG. 1.

FIG. 7 is a view showing a case where a charging operation is completed only by rapid charging and a case where a rapid charging operation is switched to a normal charging operation for charging completion in controlling charging of a battery.

### DETAILED DESCRIPTION OF THE EMBODIMENT(S)

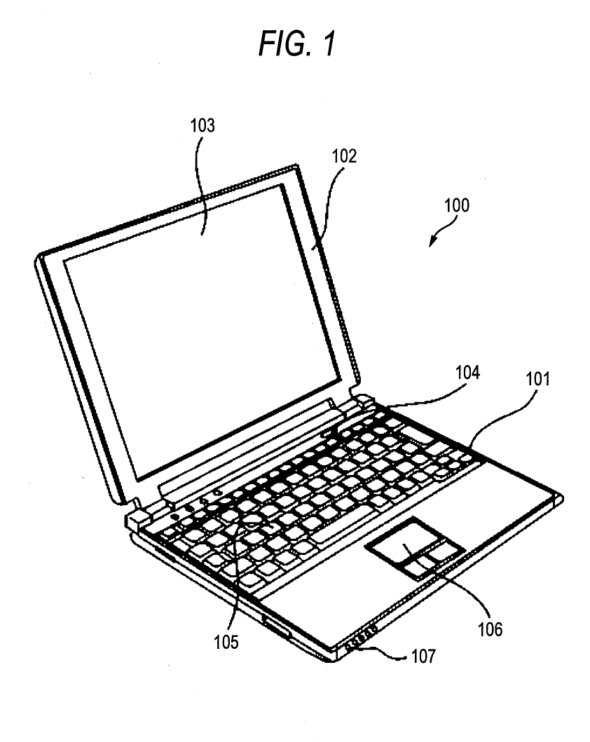

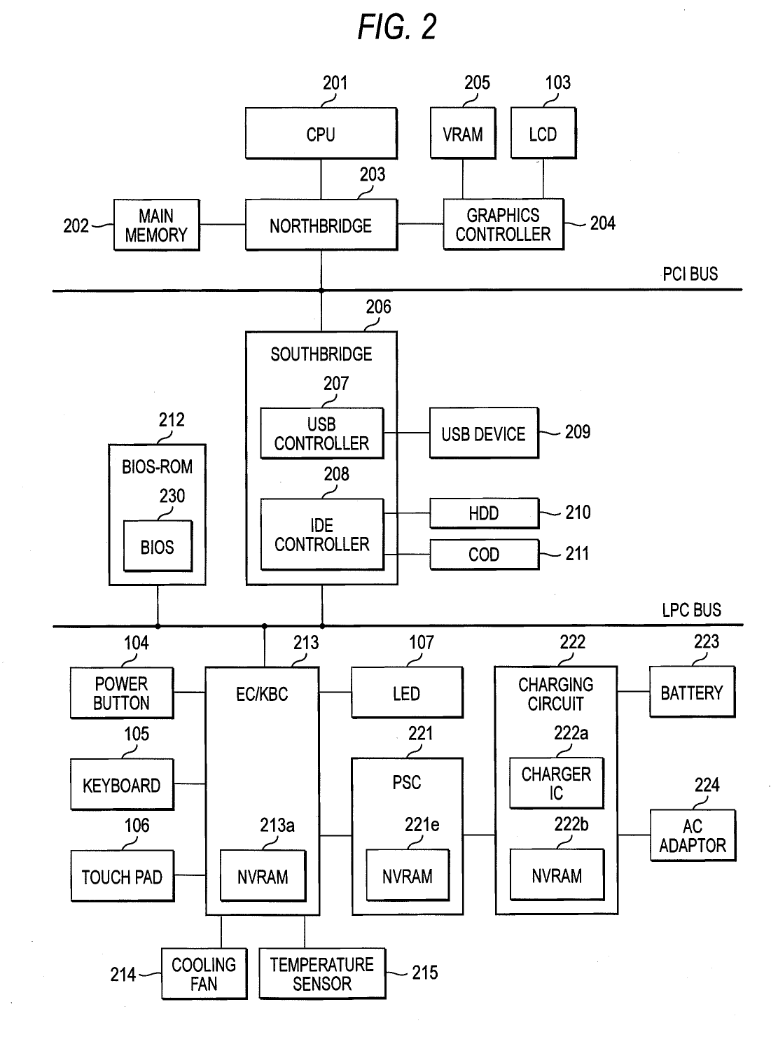

Hereinafter, an embodiment of the present invention will be described with reference to the drawings. A configuration of an information processing apparatus according to an embodiment of the present invention will be described with reference to FIGS. 1 and 2. The information processing apparatus is implemented as, for example, a battery-powered notebook-type personal computer 100 (hereinafter simply referred to as “computer 100”).

FIG. 1 is a perspective view of the computer 100 in a state where a display unit opened. The computer 100 includes a main unit 101 and a display unit 102.

The display unit 102 is assembled with a display device configured by a liquid crystal display (LCD) 103. A display screen of the LCD 103 is arranged in the substantial center of the display unit 102.

The display unit 102 is supported by the main unit 101 and is mounted thereto in such a manner to be rotatable with respect to the main unit 101 between an opened position in which the top side of the main unit 101 is exposed and a closed position in which the top side of the main unit 101 is covered.

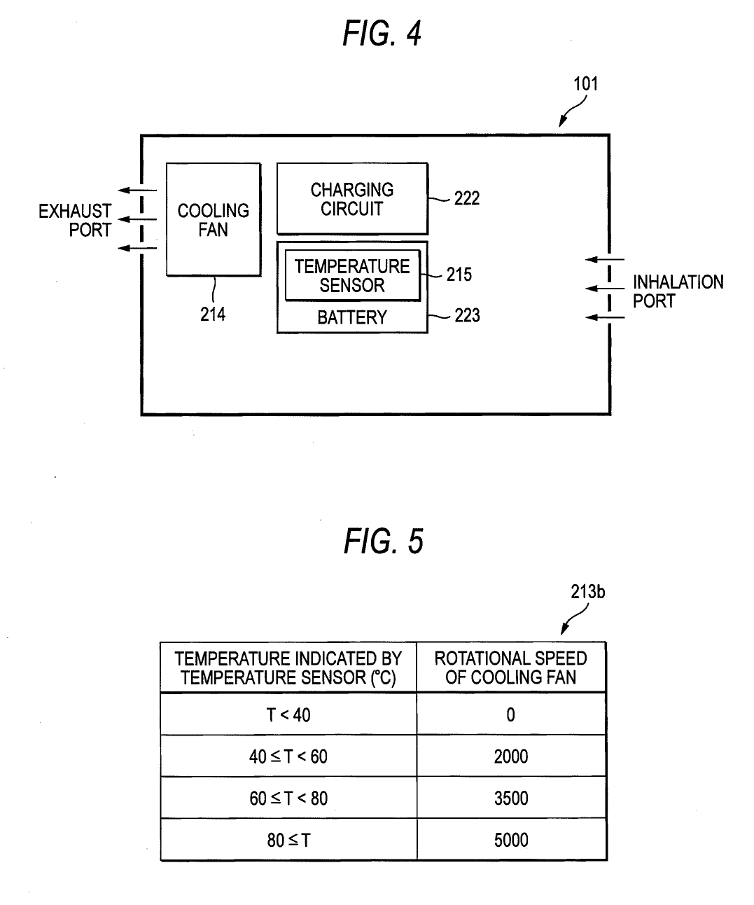

The main unit 101 has a thin box-shaped case, and a power button 104 for turning the computer 100 power on or off, a keyboard 105, a touch pad 106, etc. are arranged on the top side of the main unit 101. Alight emitting diode (LED) 107, which emits light in various luminance modes when a rapid charging operation is performed for the computer 100, is provided in the front of the main unit 101, and an exhaust port and an inhalation port (or air intake port) of a cooling fan 214 (see FIG. 2) are provided in the left side of the main unit 101 (see FIG. 4).

FIG. 2 is a block diagram showing a system configuration of the computer 100.

As shown in FIG. 2, the computer 100 includes a CPU 201, a main memory 202, a northbridge 203, a graphics controller 204, an LCD 103, a VRAM 205, a southbridge 206, a USB controller 207, an IDE controller 208, a USB device 209, a hard disk drive (HDD) 210, an optical disk drive (ODD) 211, a BIOS-ROM 212, the power button 104, the keyboard 105, the touch pad 106, the LED 107, an embedded controller/keyboard controller (EC/KBC) 213, the cooling fan 214, a temperature sensor 215, a power supply controller (PSC) 221, a charging circuit 222, a battery 223, and an AC adaptor 224.

The CPU 201 is a processor which controls the entire operation of the computer 100. The CPU 201 runs an operating system (OS) and various application programs loaded into the main memory 202. The OS and various application programs are stored in a magnetic disk storage medium (hard disk) or the like mounted in the HDD 211 and are loaded from the storage medium into the main memory 202.

The CPU 201 also runs a BIOS program 230 (hereinafter abbreviated as “BIOS”) stored in the BIOS-ROM 212. The BIOS-ROM 212 is in the form of a program-rewritable nonvolatile memory such as a flash EEPROM.

The BIOS 230 is a program which controls various hardware components of the computer 100 and is read from the BIOS-ROM 214 when the computer 100 is activated.

The northbridge 203 is a bridge device which interconnects a local bus of the CPU 201 and the southbridge 206. The northbridge 203 has a memory controller which accesses and controls the main memory 202. The northbridge 203 also has a function of communicating with the graphics controller 204 via an accelerated graphics port (AGP) bus or the like.

The graphics controller 204 is a controller which controls the LCD 103 used as a display monitor of the computer 100. The graphics controller 204 outputs an image signal, which corresponds to display data written in the VRAM 205 by using the OS or application programs, to the LCD 103.

The southbridge 206 controls various devices on a low pin count (LPC) bus and a peripheral component interconnect (PCI) bus. The southbridge 206 also contains the USB controller 207 which controls the USB device 209, and the IDE controller 208 which controls the HDD 210 and the ODD 211.

The HDD 210 is a storage device with a hard disk controller and a magnetic disk storage medium. The OS, various software and data are stored in the magnetic disk storage medium. The ODD 211 is a drive unit which drives a storage medium such as a DVD in which video contents such as a DVD title are stored or a CD in which music data are stored.

The EC/KBC 213 is a one-chip microcomputer integrated with an embedded controller (EC) for power management and a keyboard controller (KBC) which controls the keyboard 105 and the touch pad 106. The EC/KBC 213 turns on or off the power supply of the computer 100 in response to manipulation of the power button 104 by a user. The control of turning the computer 100 on or off is performed by the EC/KBC and the PSC 221 operating in tandem. The EC/KBC 213 also controls the cooling fan 214 based on information from the temperature sensor 215. The control of the cooling fan 214 is performed by a control signal sent based on a cooling fan rotational speed table corresponding to a predetermined temperature range stored in a nonvolatile memory (NVRAM) 213a included in the EC/KBC 213. Details of this control will be described later with reference to FIG. 5. The EC/KBC 213 also controls the LED 107 such that the LED 107 emits light in various luminance modes when a rapid charging operation is performed when the computer 100 is turned off. The EC/KBC 213 also instructs the PSC 221 to change a charging current flowing into the battery 223 based on temperature indicated by the temperature sensor 215.

The PSC 221 monitors the charging current for charging the battery 223 and instructs a charger IC 222a included in the charging circuit 222 to supply the charging current to the battery 223. The PSC 221 also instructs the EC/KBC 213 to control the cooling fan 214 based on the above-mentioned cooling fan rotational speed table when the rapid charging operation starts to be performed. The PSC 221 also has a nonvolatile memory (NVRAM) 221a. In the nonvolatile memory (NVRAM) 221a are stored current values indicating that the battery 223 is being rapidly charged, or the like.

The charging circuit 222 charges the battery 223 provided in the main unit 101 by using power supplied from an external power source via the AC adaptor 224 under the control of the EC/KBC 213 and the PSC 221. In more detail, the charger IC 222a included in the charging circuit 222 charges the battery 223 by controlling an operation of FETs (not shown) or the like included in the charging circuit 222. The charging circuit 222 also has a nonvolatile memory (NVRAM) 222b. In the nonvolatile memory (NVRAM) 222b of the charging circuit 222 is stored information on the ratings of the charging circuit 222.

Various devices in the computer 100 are supplied with power from the battery 223 provided in the main unit 101 or from the external power source via the AC adaptor 224.

The EC/KBC 213, the PSC 221, the charging circuit 222 and the battery 223 are interconnected via a serial bus such as an I2C bus. The EC/KBC 213 and the PSC 221 are always supplied with operation power during a period of time when the battery 223 is mounted in the main unit 101 of the computer 100 or during a period of time when the AC adaptor 224 is connected to the main unit 101. Accordingly, even when the computer 100 is turned off, the EC/KBC 213, the PSC 221 and the charging circuit 222 are in the state of being turned on.

The cooling fan 214 is a cooling fan commonly equipped in the computer 100 in order to cool heat generating bodies existing within the main unit 101 under the control of the EC/KBC 213. However, the cooling fan 214 may be exclusively provided in order to cool the charging circuit 222 in particular. This is because heat generation of FETs, coils and so on embedded in the charging circuit 222 increase during rapid charging.

The temperature sensor 215 is built, as a thermistor, into the battery 223. This is because the charging circuit 222 to be cooled is placed in the vicinity of the battery 223. Alternatively, instead of being placed in the vicinity of the battery 223, the temperature sensor 215 may be built into the charging circuit 222 or placed in vicinity of the charging circuit 222.

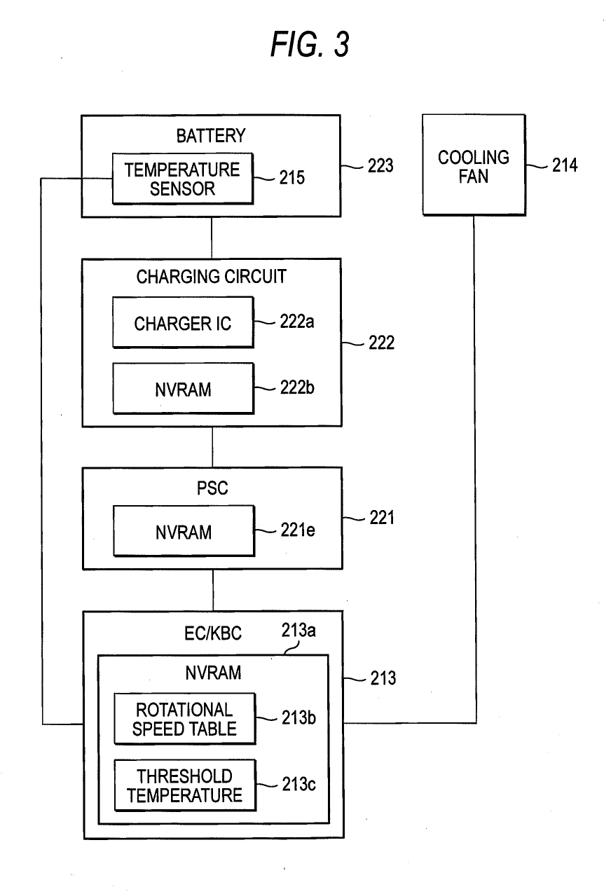

FIG. 3 is a block diagram showing a portion of the configuration of the computer 100 in more detail. Specifically, FIG. 3 is a block diagram showing the EC/KBC 213, the PSC 221, the charging circuit 222, the battery 223 and the cooling fan 214.

The nonvolatile memory (NVRAM) 213a of the EC/KBC 213 stores a rotational speed table 213b for controlling the cooling fan 214 based on information from the temperature sensor 215 and a value (t₁) 213c (for example 100° C.) which is a threshold temperature lower than the rated temperature (for example 105° C.) of the charging circuit 222.

The nonvolatile memory (NVRAM) 221a of the PSC 221 stores a predetermined current value (for example 10 A) indicating that the battery 223 is being rapidly charged and a predetermined current value (for example 4 A) indicating that the battery 223 is being normally charged. The nonvolatile memory (NVRAM) 221a of the PSC 221 also stores a first predetermined current threshold i₁ (for example 8 A) based on which the battery 223 may be assumed to be rapidly charged and a second predetermined current threshold i₂ (for example 0.5 A) indicating that the battery 223 has been completely charged.

The nonvolatile memory (NVRAM) 222b of the charging circuit 222 stores at least rating information of the rated temperature (° C.) of the charging circuit 222.

Since the battery 223 and the cooling fan 214 have been described in detail with reference to FIG. 2, explanation of these will not be here repeated.

FIG. 4 is a schematic view showing arrangement of the charging circuit 222, the cooling fan 214, the battery 223 and the temperature sensor 215 in the computer 100.

As described above, the temperature sensor 215 is built, as a thermistor, into the battery 223. The exhaust port of the cooling fan 214 is arranged in the left side of the computer 100 and the inhalation port (or air intake port) is arranged in the right side of the computer 100.

FIG. 5 is a view showing a table 500 of the relationship between the temperature T (° C.) indicated by the temperature sensor 215 and the rotational speed (rpm) of the cooling fan 214, which is stored in the nonvolatile memory (NVRAM) 213a of the EC/KBC 213.

As shown in FIG. 5, if the temperature sensor 215 indicates a temperature lower than 40° C., the EC/KBC 213 controls the cooling fan 214 so as not to be rotated. If the temperature sensor 215 indicates a temperature equal to or higher than 40° C. and lower than 60° C., the EC/KBC 213 controls the cooling fan 214 so as to be rotated at 2000 rpm, for example. If the temperature sensor 215 indicates a temperature equal to or higher than 60° C. and lower than 80° C., the EC/KBC 213 controls the cooling fan 214 so as to be rotated at 3500 rpm, for example. If the temperature sensor 215 indicates a temperature equal to or higher than 80° C., the EC/KBC 213 controls the cooling fan 214 so as to be rotated at 5000 rpm, for example.

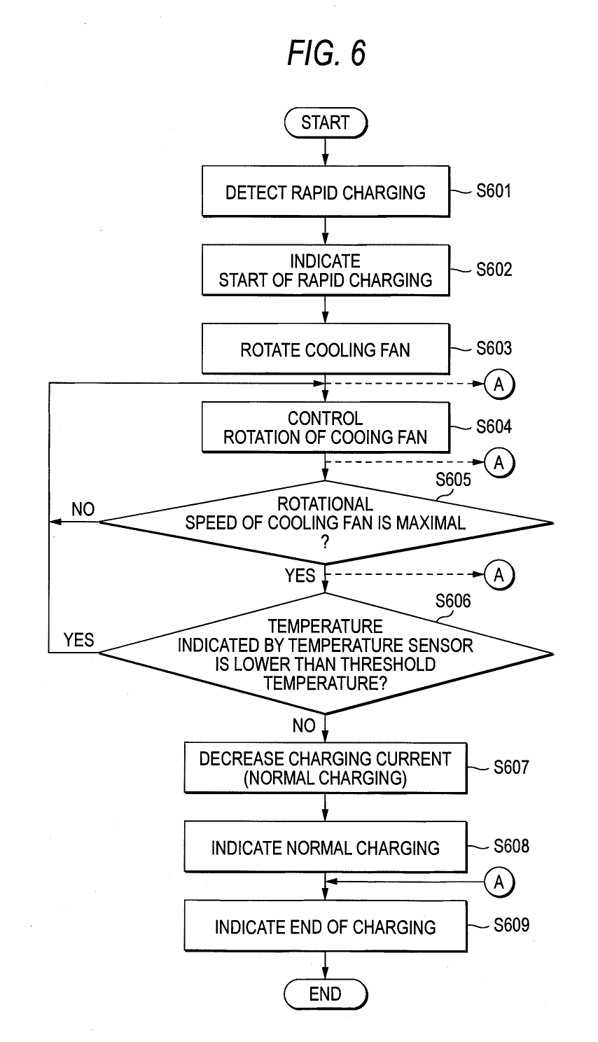

Next, an operation of the above configuration will be described. FIG. 6 shows an example charging control method of the battery 223, which is used in the computer 100. In this example, it is assumed that the computer 100 is turned off and the battery 223 is charged from an external power source via the AC adaptor 224. In addition, as described above, the EC/KBC 213, the PSC 221 and the charging circuit 222 are turned on even when the computer 100 is turned off.

First, when the computer 100 is turned off, the PSC 221 instructs the charger IC 222a included in the charging circuit 222 to supply a current (for example 10 A) corresponding to rapid charging to the battery 223. Based on the instruction, the charger IC 222a initiates the charging of the battery 223 by controlling an operation of FETs (not shown) or the like included in the charging circuit 222.

The PSC 221 monitors the current supplied to the battery 223, and if the supplied current exceeds the first predetermined current threshold i₁ (for example 8 A) stored in the nonvolatile memory (NVRAM) 221a of the PSC 221, the PSC 221 recognizes that the battery 223 has started to be rapidly charged (Step S601).

Subsequently, the PSC 221 informs the EC/KBC 213 of the start of the rapid charging, and the EC/KBC 213 controls the LED 107 to emit light in a first luminance mode and informs a user of the start of the rapid charging (Step S602). An example of the first luminance mode may include turning on or off a light with a predetermined color such as yellow or green.

Subsequently, based on the temperature indicated by the temperature sensor 215 and the rotational speed table 213b, the EC/KBC 213 controls the cooling fan 214 so as to be rotated or remain still (Steps S603 and S604).

Next, the EC/KBC 213 determines whether or not the cooling fan 214 is being rotated at the maximum rotational speed (Step S605). This determination is made based on a signal sent from the cooling fan 214 to the EC/KBC 213, which indicates that the cooling fan 214 is being rotated at the maximum rotational speed.

If the cooling fan 214 is not being rotated at the maximum rotational speed (NO in Step S605), the operation returns to Step S604 and the subsequent processes are repeated.

On the other hand, if the cooling fan 214 is being rotated at the maximum rotational speed (YES in Step S605), the EC/KBC 213 determines whether or not the temperature indicated by the temperature sensor 215 is lower than the threshold temperature t₁ (for example 100° C.) previously stored in the nonvolatile memory 213c of the EC/KBC 213 (Step S606).

If the temperature indicated by the temperature sensor 215 is lower than the threshold temperature t₁ (YES in Step S606), the operation returns to Step S604 and the subsequent processes are repeated.

On the other hand, if the temperature indicated by the temperature sensor 215 is equal to or higher than the threshold temperature t₁ (NO in Step S606), the EC/KBC 213 instructs the charger IC 222a to charge the battery 223 with the same supply current as is used for normal charging via the PSC 221. In response to the instruction, the charger IC 222a continues to charge the battery 223 by instructing FETs (not shown) or the like included in the charging circuit 222 to supply a predetermined current (for example 4 A) lower than the first predetermined current threshold i₁ (for example 8A) to the battery 223 (Step S607).

Subsequently, the PSC 221 informs the EC/KBC 213 that the rapid charging is switched to the normal charging, and the EC/KBC 213 controls the LED 107 to emit light in a second luminance mode different from the first luminance mode and informs the user of the switching to the normal charging (Step S608). An example of the second luminance mode may include turning on or off a light with a predetermined color such as yellow or green.

Then, when the PSC 221 monitoring the supply current to the battery 223 detects the second predetermined current threshold i₂ (for example 0.5 A) previously stored in the nonvolatile memory (NVRAM) 221a, which indicates completion of the charging to the battery 223, the charging operation has ended. At this time, the PSC 221 informs the EC/KBC 213 that the charging operation has ended, and the EC/KBC 213 controls the LED 107 to emit light in a third luminance mode different from the first and second luminance modes and informs the user that the charging operation has ended (Step S609). Likewise, also in the case where the rapid charging has ended between Steps S603 and S606 without switching to the normal charging (indicated by an arrow A in the figure), the EC/KBC 213 controls the LED 107 to emit light in the third luminance mode different from the first and second luminance modes and informs the user that the charging operation has ended (Step S609). An example of the third luminance mode may include turning on or off a light with a predetermined color such as yellow or green. Then, the operation is ended.

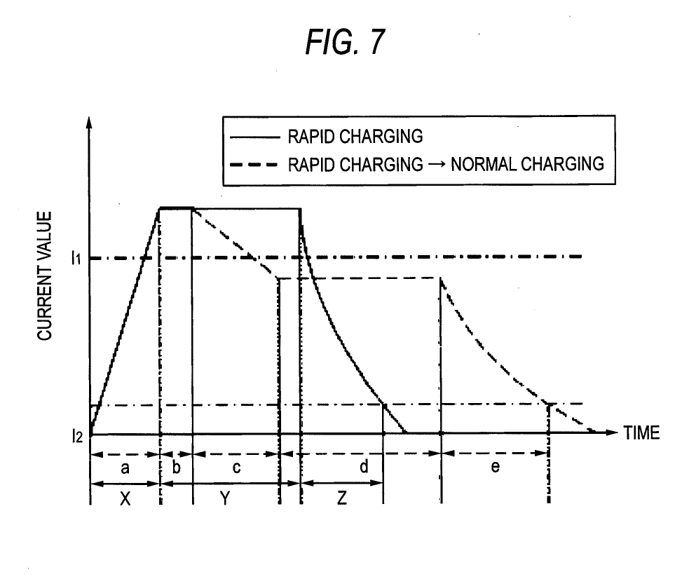

Next, as a supplement for the operation of FIG. 6, when the charging of the battery 223 is controlled, the case where the charging operation is completed only by the rapid charging and the case where the rapid charging is switched to the normal charging for completion of the charging operation will be described with reference to FIG. 7. In this figure, a solid line represents temporal change of a charging current value in the rapid charging and a dashed line represents temporal change of a charging current value when the rapid charging is switched to the normal charging.

First, a current starts to be supplied to the battery 223, and it can be seen that a current value reaches the first predetermined current threshold i₁ (for example 8 A) indicating that the PSC 221 can consider that the battery 223 was rapidly charged in intervals a and X.

In the case where the charging operation is ended only by the rapid charging, the rapid charging continues with a current value (for example 10 A) corresponding to the rapid charging in an interval Y. In an interval Z, it can be seen that the charging operation has ended and the supply current value decreases and reaches the second predetermined current threshold i₂ (for example 0.5 A) (Step S609 of FIG. 6) which is a current value indicating that the PCS 221 can recognize that the charging to the battery 223 has ended.

On the other hand, in the case where the rapid charging is switched to the normal charging for completion of the charging operation, the rapid charging continues with a current value (for example 10A) corresponding to the rapid charging in an interval b. Thereafter, in an interval c, the rotational speed of the cooling fan 214 is at a maximum (NO in Step S606 of FIG. 6), the PCS 221 instructs the charger IC to charge the battery 223 with the predetermined current value (for example 4 A) corresponding to the normal charging (Step S607 of FIG. 6), and the charging current starts to decrease. Subsequently, in an interval d, the charging operation continues with the predetermined current value (for example 4 A) corresponding to the normal charging. Finally, in an interval e, it can be seen that the charging operation has ended and the supply current value decreases and reaches the second predetermined current threshold i₂ (for example 0.5 A) (Step S609 of FIG. 6) which is a current value indicating that the PCS 221 can recognize that the charging to the battery 223 has ended.

As described above, according to this embodiment, by rotating the cooling fan for rapid charging even when the computer 100 is turned off, it is possible to radiate heat from parts of a charger (parts in the charging circuits 222) and extend the durability of the parts and hence improve the reliability of the computer 100. In addition, if the inhalation and exhaust ports are clogged or the cooling fan is dusty, while the parts of the charger (parts in the charging circuit 222) or the battery 223 may not be controlled so as to fall within a rated temperature range only by rotation of the cooling fan, the charging current control according to the present invention can improve the safety and reliability of the computer 100.

In addition, according to this embodiment, a user'can recognize the start and end of the rapid charging even when the computer 100 is turned off, thereby allowing compatibility of charging in a short period of time with the convenience of the user.

In addition, according to this embodiment, since the present invention can be practiced using combinations of existing components equipped in the computer 100, additional parts are not required and product costs will not increase.

While the preferred embodiments of the present invention have been shown and described in the above, the present invention is not limited to the above embodiments but it is to be understood that modifications and changes may be made without departing from the spirit and scope of the invention.

For example, although it has been illustrated in the above embodiments that the LED 107 is used to indicate a user of the start and end of the rapid charging, the rotation speed of the fan 214 may be set to maximum for a predetermined period of time at starting and ending of rapid charging. In addition, in FIG. 7, if the duration of the intervals b and Y is measured and if the measurement is lower than a predetermined value, it is recognized that “the charging current was not decreased during the rapid charging,” and a user may be informed of such change by changing the indicator display accordingly.

As described above, according to the present invention, it is possible to rapidly charge an internal battery of an information processing apparatus even when the information processing apparatus is turned off and control heat generation generated by the rapid charging.

What is claimed is:

1. An information processing apparatus comprising:
a heat generating body;
a temperature sensor configured to detect a temperature of the heat generating body and to output a value indicative of the temperature;
a battery;
an adaptor configured to charge the battery; and
a controller configured to control charging of the battery with a rapid charging operation or a normal charging operation, based on the temperature value and a threshold temperature value lower than a rated temperature of the heat generating body, while the information processing apparatus is turned off.

2. The apparatus of claim 1,
wherein the controller is configured to charge the battery in the normal charging operation when the temperature value is equal to or higher than the threshold temperature value, and
wherein the controller is configured to charge the battery in the rapid charging operation when the temperature value is lower than the threshold temperature value.

3. The apparatus of claim 2 further comprising:
a cooling fan configured to cool the heat generating body, and
wherein the controller is configured to compare the temperature value with the threshold temperature value when the cooling fan is rotating at maximum speed.

4. The apparatus of claim 1 further comprising:
a first indicator configured to indicate that the rapid charging has started.

5. The apparatus of claim 1 further comprising:
a second indicator configured to indicate that the normal charging has started.

6. The apparatus of claim 1 further comprising:
a third indicator configured to indicate that the is completed when the charging operation is completed.

7. The apparatus of claim 1,
wherein the heat generating body. is a charging circuit between the adaptor and the battery.

8. A method for controlling battery charge used for an information processing apparatus comprising:
a heat generating body;
a temperature sensor configured to detect a temperature of the heat generating body and to output a value indicative of the temperature;
a battery in the information processing apparatus;
an adaptor configured to charge the battery; and
a controller configured to control a battery charging operation,
the method comprising:
controlling the charging of the battery with a rapid charging operation or a normal charging operation, based on the temperature value and a threshold temperature value lower than a rated temperature of the, heat generating body, while the information processing apparatus is turned off.

9. The method of claim 8,
wherein the controller is configured to control the battery charging operation in the normal charging when the temperature value is equal to or higher than the threshold temperature value, and
wherein the controller is configured to control the battery charging operation in the rapid charging when the temperature value is lower than the threshold temperature value.

10. The method of claim 9,
wherein the information processing apparatus comprises a cooling fan configured to cool the heat generating body, and
wherein the controller is configured to compare the temperature value with the threshold temperature value when the cooling fan is rotating at a maximum speed.
